(19) United States
(12) Patent Application Publication
(10) Pub. No.: US 2007/0069568 A1
(43) Pub. Date: Mar. 29, 2007

(54) Auxiliary safety belt for a child seat

(76) Inventors: Tien-Fu Kuo, Taipei City (TW); Tsai-Yuan Chien, Taipei City (TW)

Correspondence Address: RABIN & Berdo, PC, 1101 14TH STREET, NW, SUITE 500, WASHINGTON, DC, 20005, US

(21) Appl. No.: 11/233,033

(22) Filed: Sep. 23, 2005

(51) Int. Cl. B60R 22/00

(52) U.S. Cl. 297/468

(57) ABSTRACT

An auxiliary safety belt has a main body having a U shaped primary strap and two loops formed on two ends of the primary strap for extension of the horizontal portion of the onboard safety belt, a connection belt having a connection loop formed on a distal end thereof to have a portion of the primary strap extended therethrough and a fastening device formed on a proximal end of the connection belt and having a hook to connect to an onboard buckle seat. Therefore, a wrap-around protection to the user is provided should there be a sudden pull to the user riding a vehicle.

### BACKGROUND OF THE INVENTION

1. Field of the Invention

The present invention relates to a safety belt, and more particularly to an auxiliary safety belt for a child seat to evenly distribute stress to a child from an abrupt halt of a vehicle.

2. Description of Related Art

A transportation purpose-orientated vehicle is required to be equipped with safety belts to ensure safety of the passenger(s) onboard the vehicle. However, when the passenger is under age, by Law, the driver is required to add in child seat to prevent any mishap to the passenger. We all know it very well that a child seat is pretty bulky so that the available space inside the vehicle is very much limited. Further, when the passenger is still an infant, the driver has to carry all the way of the child seat to originally planned destination, which is quite inconvenient to the driver. Another downside of the current child seat is that whether the child seat is able to be securely fastened on the onboard seat of the vehicle becomes a potential threat to the passenger on board and the driver as well when the child seat moves as a result of loose connection to the existing onboard safety belt. Besides, buying a child seat is the acronym of increasing the expense, which is normally not acceptable for most of families living under average.

To overcome the aforementioned disadvantages, the present invention provides an improved auxiliary safety belt.

Other objects, advantages and novel features of the invention will become more apparent from the following detailed description when taken in conjunction with the accompanying drawings

### SUMMARY OF THE INVENTION

The primary objective of the present invention is to provide an improved safety belt, with which the user is able to incorporate the auxiliary safety belt of the present invention with the existing onboard safety belt to ensure safety of the passenger.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the auxiliary safety belt of the present invention;

FIG. 2 is a partial perspective view of the safety belt of the present invention;

FIG. 3 is a perspective view showing the application of the hook of the safety belt of the present invention;

FIG. 4 is a schematic cross sectional view showing the connection of the fastening device of the present invention to the existing buckle of the onboard safety belt;

FIG. 5 is an exploded perspective view of the fastening device of the present invention; and

FIGS. 6, 7 and 8 are schematic views showing the application of the present invention.

### DETAILED DESCRIPTION OF PREFERRED EMBODIMENT

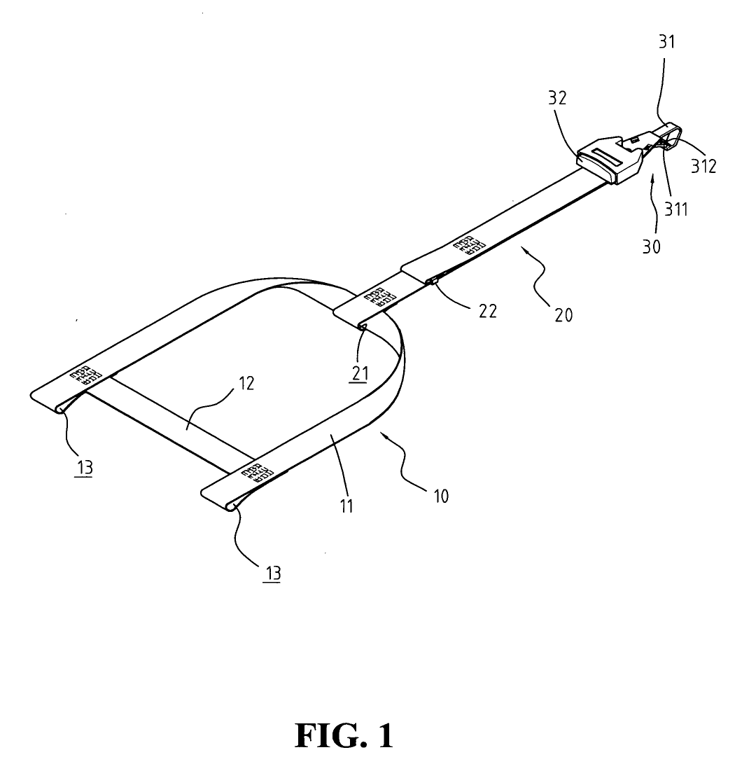

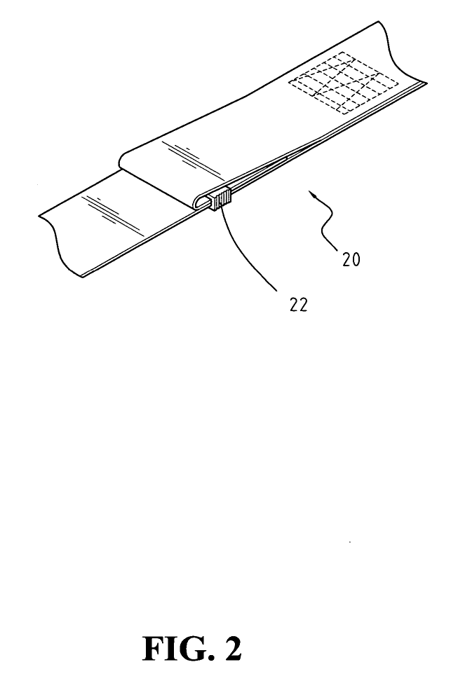

With reference to FIGS. 1 and 2, it is noted that the auxiliary safety belt in accordance with the present invention includes a main body 10, a connection belt 20 and a fastening device 30.

The main body 10 is composed of a U shaped primary strap 11 and a crossbar 12 securely connecting two distal ends of the primary strap 11. Each distal end of the primary strap 11 is formed with a loop 13 and the connection of the crossbar 12 to each of the two distal ends of the primary strap 11 is away from the place where the loop 13 is formed so that the loop 13 is not hindered to allow interaction with other elements.

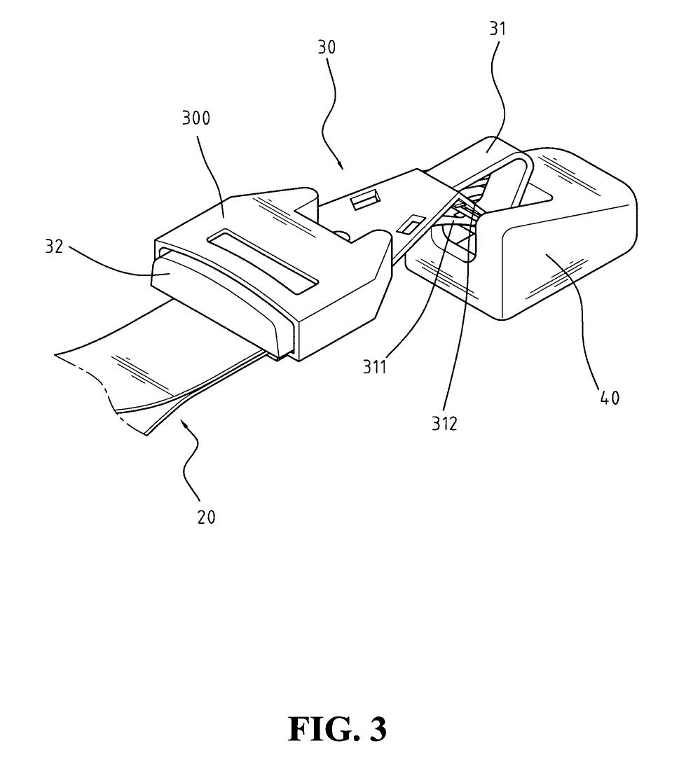

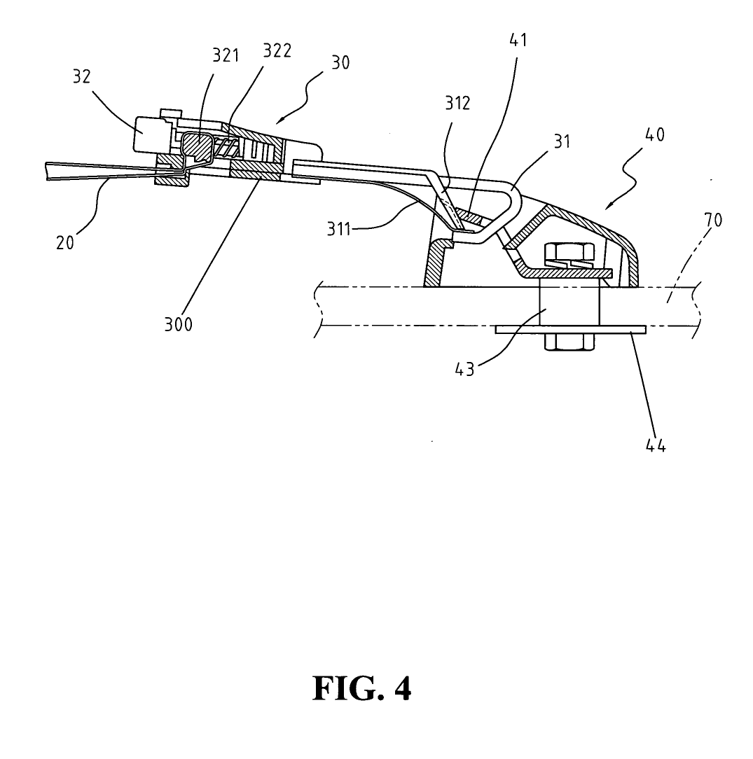

The connection belt 20 has a connection loop 21 formed on a distal end thereof and an adjusting ring 22 formed on a mediate portion thereof. The fastening device 30, as shown in FIGS. 3, 4 and 5, constructed in accordance with the present invention includes a hook 31 formed on a distal end thereof and an adjusting knob 32 formed on a proximal end thereof and movably received in a housing 300, a linkage 321 is securely connected to the adjusting knob 32 and a resilient element 322 is sandwiched between a bottom face of the housing 300 and a bottom face of the linkage 321 so that the adjusting knob 32 is urged by the resilient element 322 outward in relation to the housing 300. It is noted that the proximal end of the connection belt 20 extends around the linkage 321 and securely engages with the adjusting ring 22 to form a hoop such that when the linkage 321 as well as the adjusting knob 32 is pushed outward by the resilient element 322, the connection belt 20 is immovable relative to the linkage 321 and when the adjusting knob 32 is pushed into the housing 300, the hoop is able to be adjusted to adapt the length required for the user. In addition to the hook 31, a baffle plate 312 is provided to an opening of the hook 31 and a resilient block 311 is provided at the bottom of the baffle plate 312 to prevent unintentional loose of the baffle plate 312 relative to the hook 31 so that the baffle plate 312 is able to block the opening of the hook 31 at all times unless particularly required.

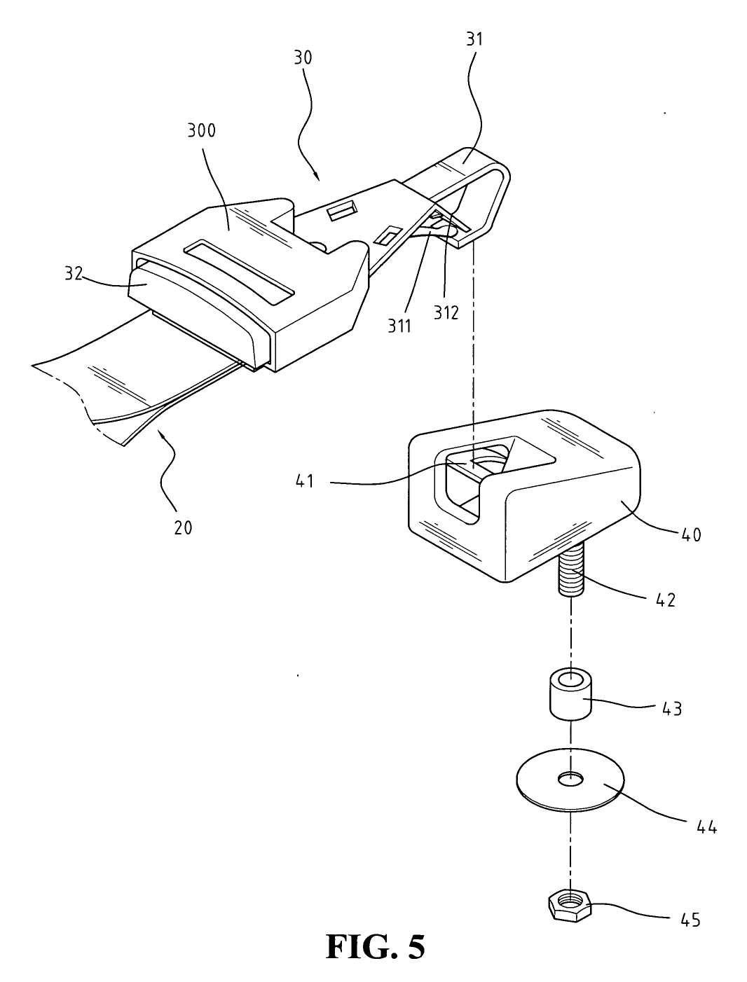

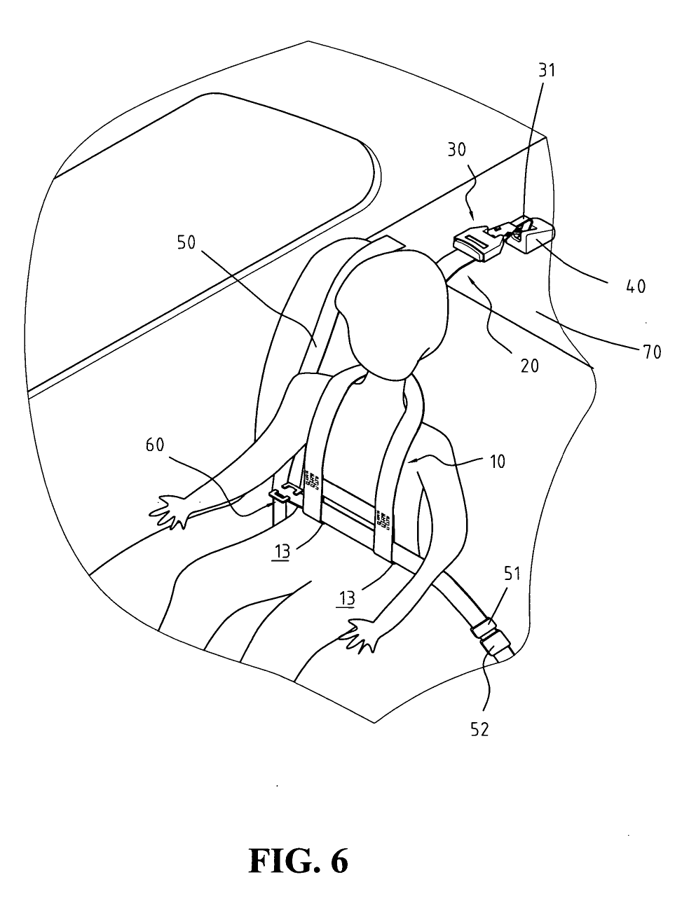

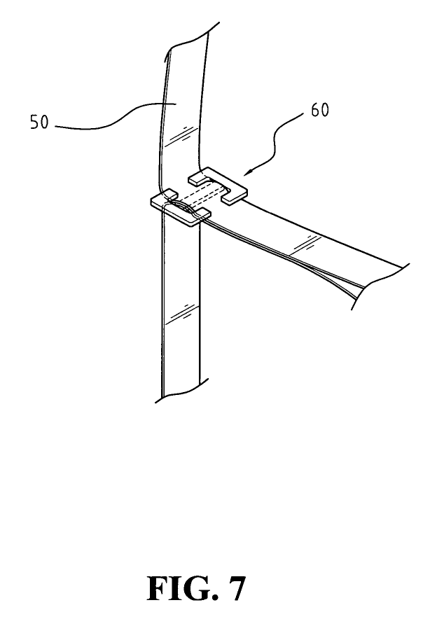

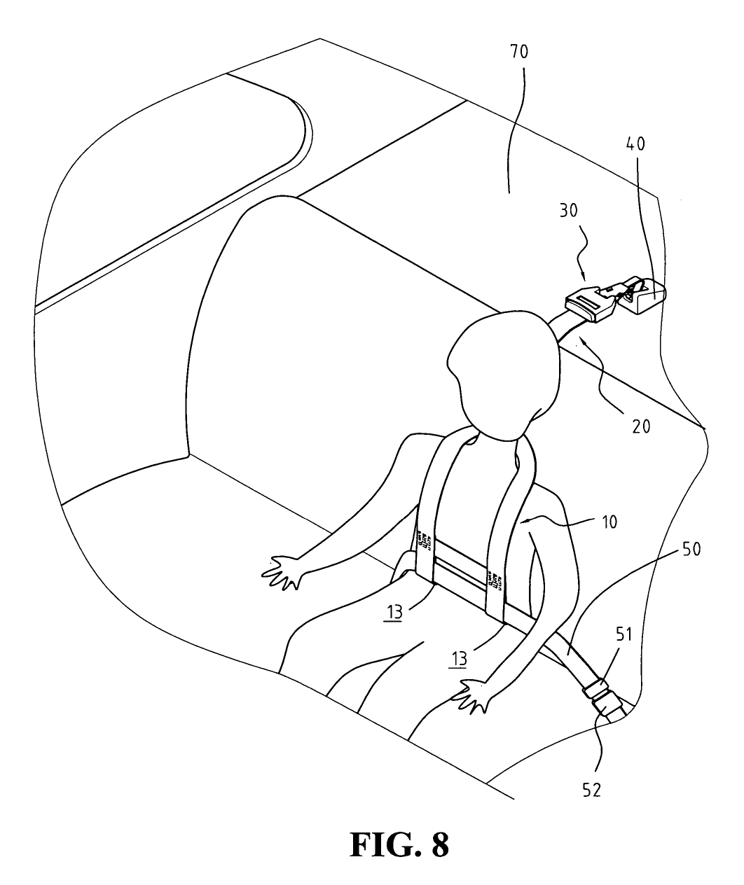

With reference to FIGS. 6, 7 and 8 and still using FIG. 5 for reference, when the auxiliary safety belt of the present invention is in application with a buckle seat 40 having a buckle 41 securely received in the buckle seat 40, a bolt 42 extending downward from the buckle seat 40, a collar 43 having a hole defined in a center of the collar 43 to allow extension of the bolt 42, a disk 44 also having a central hole defined in the center of the disk 44 to allow the extension of the bolt 42 and a nut 45 to secure the bolt 42 after passing through the collar 43 and the disk 44 so that the buckle seat 40 is able to be mounted on a face 70 of the vehicle. Therefore, the hook 31 is able to engage with the buckle 41 and the baffle plate 312 as well as the resilient block 311 is able to secure the engagement between the hook 31 and the buckle 41. From the showing of FIGS. 6 and 8, it is noted that the conventional onboard safety belt includes an L shaped belt 50 and a fixing element 60. The hook 31 of the fastening device 30 is securely connected to the buckle seat 40 and the primary strap 11 of the main body 10 is placed on the user's body to allow the user's head to extend through the U shaped primary strap 11 so that a large portion of the primary strap 11 falls on the user's shoulder. Then the horizontal portion of the L shaped conventional safety belt 50 extends through the two loops 13 to allow two ends of the horizontal portion o the conventional safety belt 50 to respectively and securely connected to the vertical portion of the safety belt 50 via the fixing element 60 and via a buckle head-buckle seat 51,52 combination, wherein the buckle seat 52 is firmly connected to the vehicle.

If the tension of the conventional safety belt 50 needs to be adjusted, the user is able to use the fixing element 60 to adjust it to avoid discomfort.

It is to be noted that the auxiliary safety belt of the present invention provides a wrap-around support to the user so as to evenly distribute the sudden pull from the safety belt should there be a sudden halt of or impact to the vehicle. Furthermore, the auxiliary belt of the present invention is easy to carry and light weight. Especially there is not much space required to store the present invention so that the available space inside the vehicle is sustained.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An auxiliary safety belt used in conjunction with an onboard safety belt having an L shaped strap which is composed of a vertical portion and a horizontal portion a distal end thereof is movably connected to the vertical portion and a proximal end thereof is securely connected to a portion of a vehicle via a buckle head-buckle seat combination, the auxiliary safety belt comprising:
a main body having a U shaped primary strap and two loops formed on two ends of the primary strap for extension of the horizontal portion of the onboard safety belt;
a connection belt having a connection loop formed on a distal end thereof to have a portion of the primary strap extended therethrough; and
a fastening device formed on a proximal end of the connection belt and having a hook to connect to an onboard buckle seat.

2. The auxiliary safety belt as claimed in claim 1, wherein the connection belt further has an adjusting ring to adjust length of the connection belt.

3. The auxiliary safety belt as claimed in claim 1, wherein the fastening device includes a housing from which the hook extends, a baffle plate formed on a bottom of the housing to close an opening of the hook and a resilient block formed on a bottom of the baffle plate to prevent unintentional opening of the hook.

4. The auxiliary safety belt as claimed in claim 2, wherein the fastening device includes a housing from which the hook extends, a baffle plate formed on a bottom of the housing to close an opening of the hook and a resilient block formed on a bottom of the baffle plate to prevent unintentional opening of the hook.

5. The auxiliary safety belt as claimed in claim 4, wherein an adjusting knob is extended outside the housing, a linkage is formed to extend from the adjusting knob and a resilient element is sandwiched between the linkage and a bottom face of the housing to provide resilient to the adjusting knob and to urge the adjusting knob away from the housing.

6. The auxiliary safety belt as claimed in claim 5, wherein the proximal end of the connection belt extends over the linkage to securely connect to the adjusting ring such that when the adjusting knob is pushed by the resilient element to be away from the housing, length of the connection belt is not adjustable and when the adjusting knob is pushed toward the housing, the length of the connection belt is adjustable.

7. The auxiliary safety belt as claimed in claim 1, wherein the buckle seat has a buckle securely received in the buckle seat, a bolt extending downward from the buckle seat, a collar having a hole defined in a center of the collar to allow extension of the bolt, a disk having a central hole defined in the center of the disk to allow the extension of the bolt and a nut to secure the bolt after passing through the collar and the disk so that the buckle seat is able to be mounted on a face of the vehicle.

8. The auxiliary safety belt as claimed in claim 2, wherein the buckle seat has a buckle securely received in the buckle seat, a bolt extending downward from the buckle seat, a collar having a hole defined in a center of the collar to allow extension of the bolt, a disk having a central hole defined in the center of the disk to allow the extension of the bolt and a nut to secure the bolt after passing through the collar and the disk so that the buckle seat is able to be mounted on a face of the vehicle.

9. The auxiliary safety belt as claimed in claim 3, wherein the buckle seat has a buckle securely received in the buckle seat, a bolt extending downward from the buckle seat, a collar having a hole defined in a center of the collar to allow extension of the bolt, a disk having a central hole defined in the center of the disk to allow the extension of the bolt and a nut to secure the bolt after passing through the collar and the disk so that the buckle seat is able to be mounted on a face of the vehicle.

10. The auxiliary safety belt as claimed in claim 4, wherein the buckle seat has a buckle securely received in the buckle seat, a bolt extending downward from the buckle seat, a collar having a hole defined in a center of the collar to allow extension of the bolt, a disk having a central hole defined in the center of the disk to allow the extension of the bolt and a nut to secure the bolt after passing through the collar and the disk so that the buckle seat is able to be mounted on a face of the vehicle.

11. The auxiliary safety belt as claimed in claim 5, wherein the buckle seat has a buckle securely received in the buckle seat, a bolt extending downward from the buckle seat, a collar having a hole defined in a center of the collar to allow extension of the bolt, a disk having a central hole defined in the center of the disk to allow the extension of the bolt and a nut to secure the bolt after passing through the collar and the disk so that the buckle seat is able to be mounted on a face of the vehicle.

12. The auxiliary safety belt as claimed in claim 6, wherein the buckle seat has a buckle securely received in the buckle seat, a bolt extending downward from the buckle seat, a collar having a hole defined in a center of the collar to allow extension of the bolt, a disk having a central hole defined in the center of the disk to allow the extension of the bolt and a nut to secure the bolt after passing through the collar and the disk so that the buckle seat is able to be mounted on a face of the vehicle.
